(19) United States
(12) Patent Application Publication
(10) Pub. No.: US 2013/0164974 A1
(43) Pub. Date: Jun. 27, 2013

(54) TELESCOPIC DEVICE FOR SECURING LAMP TO SOCKET

(71) Applicant: Tzung-Shiun Tsai, Kaohsiung (TW)

(72) Inventor: Tzung-Shiun Tsai, Kaohsiung (TW)

(21) Appl. No.: 13/449,943

(22) Filed: Apr. 18, 2012

(30) Foreign Application Priority Data
Dec. 22, 2011 (TW) 100224234
Dec. 22, 2011 (TW) 100224235

(51) Int. Cl. H01R 13/60

(52) U.S. Cl. 439/541

(57) ABSTRACT

A conductive telescopic device is provided with a conductive member releasably connected to an electrical socket in a fixture body; a hollow member having one end secured to the conductive member; a sleeve comprising a shell, a shaft member slidably disposed in a lower portion of the shell and including a recess on a surface, a sleeving member secured onto a lower portion of the shaft member, and an eccentric spiral member disposed on the shaft member and including a latch end complimentary to the recess; a socket member for releasably holding at least one lamp; a hollow connecting member having one end secured to the sleeving member and the other end secured to the socket member; and an electrical wire electrically connected to the conductive member and the socket member. A rotation of the shaft member about the shell can lengthen or shorten the telescopic device.

### BACKGROUND OF THE INVENTION

1. Field of the Invention

The invention relates to street lights and more particularly to a street light having a telescopic device for securing a lamp to one of at least one socket of a fixture body of the street light so that strength of the emitted light can be adjusted.

2. Description of Related Art

A street light is a raised source of light on the edge of a road or walkway. It is turned on at a certain time every night. Modern street lights may also have light-sensitive photocells to turn them on at dusk, off at dawn, or activate automatically in dark weather. It is common for street lights to be on posts which have wires strung between them, such as on telephone poles or utility poles.

However, a number of drawbacks have been found in the conventional street lights. In detail, its light strength cannot be adjusted due to the fixed mounting of a lamp to a socket. Further, its illumination angle is not adjusted due to the same reason.

Thus, the need for improvement still exists.

### SUMMARY OF THE INVENTION

It is therefore one object of the invention to provide a conductive telescopic device comprising a conductive member releasably connected to an electrical socket in a fixture body; a hollow member having one end secured to the conductive member; a sleeve comprising a shell, a shaft member slidably disposed in a lower portion of the shell and including a recess on a surface, a sleeving member secured onto a lower portion of the shaft member, and an eccentric spiral member disposed on the shaft member and including a latch end complimentary to the recess; a socket member for releasably holding at least one lamp; a hollow connecting member having one end secured to the sleeving member and the other end secured to the socket member; and an electrical wire electrically connected to the conductive member and the socket member; wherein a rotation of the shaft member about the shell in a first direction moves the latch end in the recess for locking so as to allow the sleeving member to slide in the shell; and wherein a subsequent rotation of the shaft member about the shell in a second direction opposite the first direction disengages the latch end from the recess to lockingly engage the eccentric spiral member with an inner surface of the shell.

The above and other objects, features and advantages of the invention will become apparent from the following detailed description taken with the accompanying drawings.

### BRIEF DESCRIPTION OF THE DRAWINGS

FIG. 1 is an exploded perspective view of a fixture body and a telescopic device of a street light according to a first preferred embodiment of the invention;

FIG. 2 is a perspective view of the assembled telescopic device of FIG. 1;

FIG. 3 is an exploded perspective view of a fixture body and a telescopic device of a street light according to a second preferred embodiment of the invention;

FIG. 4 is a perspective view of the assembled telescopic device of FIG. 3;

FIG. 5A is a schematic side elevation of the sleeve showing a counterclockwise rotation of the shaft member about the shell;

FIG. 5B is a view similar to FIG. 5A showing the latch end locked in the recess at the end of the counterclockwise rotation with length of the telescopic device being decreased by freely sliding;

FIG. 5C is a view similar to FIG. 5B showing the length of the telescopic device being increased by freely sliding;

FIG. 5D is a schematic side elevation of the sleeve showing a clockwise rotation of the shaft member about the shell;

FIG. 6 is an exploded perspective view of a fixture body and a telescopic device of a street light according to a third preferred embodiment of the invention;

FIG. 7 is an exploded perspective view of a fixture body and a telescopic device of a street light according to a fourth preferred embodiment of the invention;

FIG. 8 is an exploded perspective view of a fixture body and a telescopic device of a street light according to a fifth preferred embodiment of the invention;

FIG. 9 is an exploded perspective view of a fixture body and a telescopic device of a street light according to a sixth preferred embodiment of the invention;

FIG. 10 is a perspective view of a street light according to the invention;

FIG. 11 is a block diagram of a temperature controller of an electrical ballast of the telescopic device;

FIG. 12 is an exploded view of a telescopic device of a street light according to a seventh preferred embodiment of the invention; and

FIG. 13 is a perspective view of the assembled telescopic device of FIG. 12.

### DETAILED DESCRIPTION OF THE INVENTION

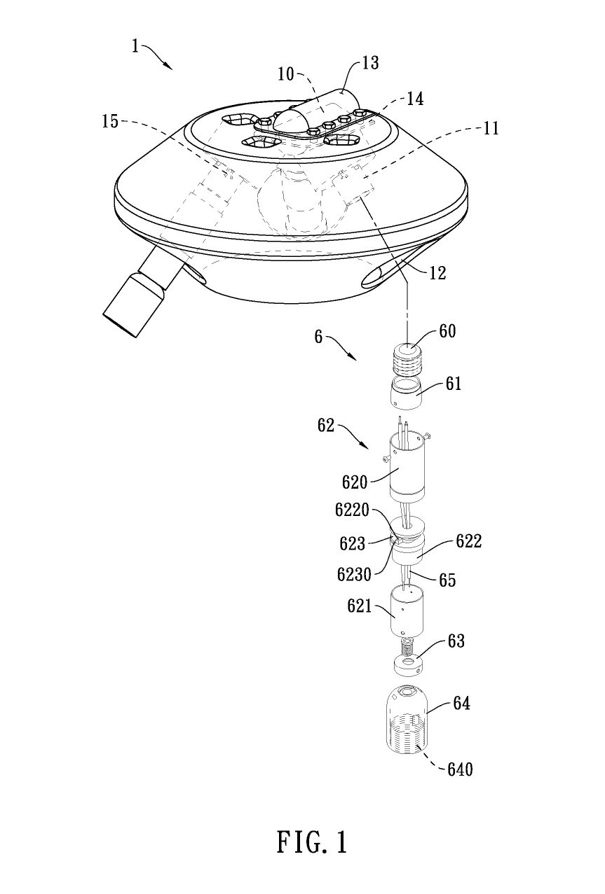

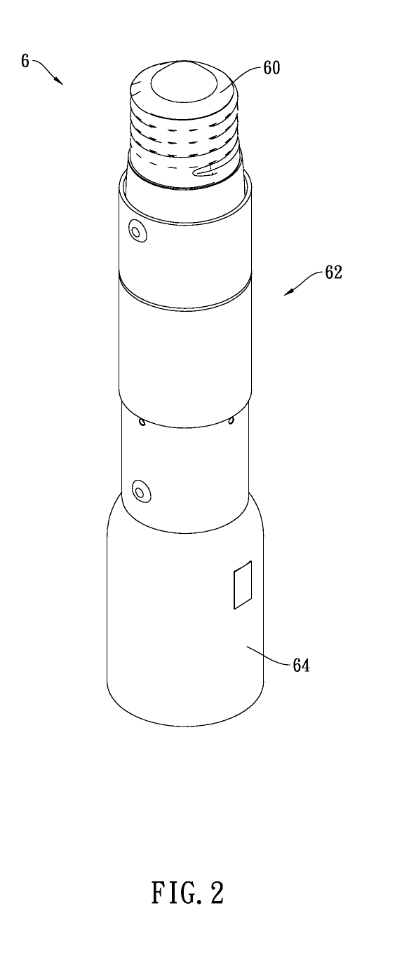

Referring to FIGS. 1 and 2, a street light having a telescopic device for securing a lamp to a socket of in accordance with a first preferred embodiment of the invention comprises the following components as discussed in detail below.

A hollow fixture body 1 is made of metal and has an outer surface coated with transparent insulating paint capable of repelling water and being resistant to corrosion. The fixture body 1 comprises a hollow top protrusion 13, a space 10 defined by the protrusion 13 and a top of the fixture body 1, three sockets 11 equally spaced around an inner surface of the fixture body 1, each socket 11 being electrically connected to an electrical wire 15, three channels 12 equally spaced around the outer surface of a inverted, truncated conic lower portion of the fixture body 1 to communicate with the sockets 11, and fastening members 14 for releasably securing one end of a pole-shaped lamp support (not shown) in the space 10 under the protrusion 13.

As shown in FIG. 1, a telescopic device 6 comprises, from top to bottom, a cylindrical conductor 60, a hollow cylindrical member 61, a sleeve 62, a hollow connecting member 63, and a socket member 64 having internal threads 640. The conductor 60 has one end releasably secured to the socket 11 and the other end secured to the hollow cylindrical member 61. An electrical wire 65 has one end secured to the conductor 60 and downward passes through the hollow cylindrical member 61, the sleeve 62, the hollow connecting member 63, and the socket member 64.

The sleeve 62 comprises a cylindrical shell 620, a shaft member 622 slidably disposed in a lower portion of the shell 620, a sleeving member 621 secured onto a lower portion of the shaft member 622, and an eccentric spiral member 623 disposed on an intermediate portion of an outer surface of the shaft member 622. The shaft member 622 comprises a recess 6220. The eccentric spiral member 623 comprises a latch end 6230 releasably secured to the recess 6220. The connecting member 63 has one end secured to the sleeving member 621 and the other end secured to the socket member 64.

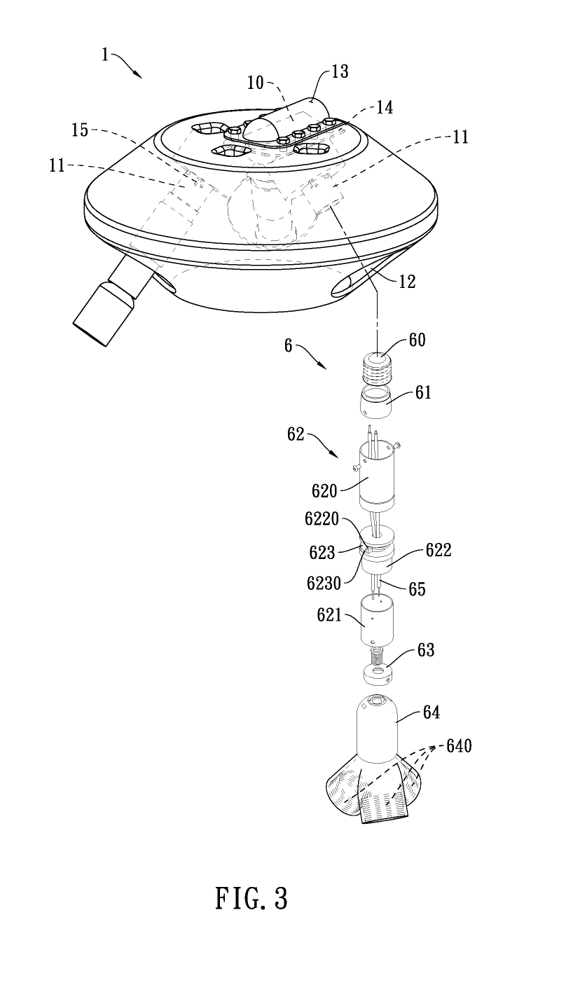

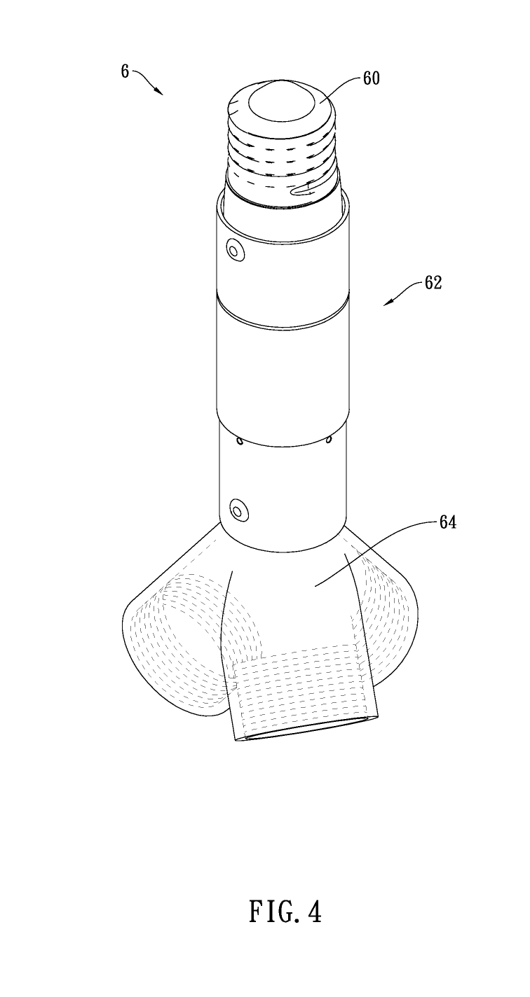

Referring to FIGS. 3 and 4, a device for securing lamp to socket in accordance with a second preferred embodiment of the invention is shown. The characteristics of the second preferred embodiment are substantially the same as that of the first preferred embodiment except the following: The socket member 64 comprises three equally spaced, lower, hollow, cylindrical extensions each having internal threads 640.

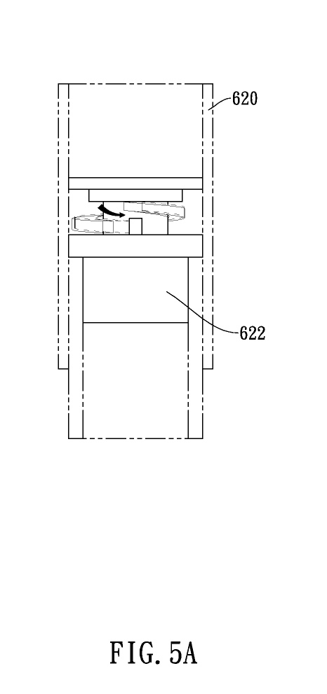

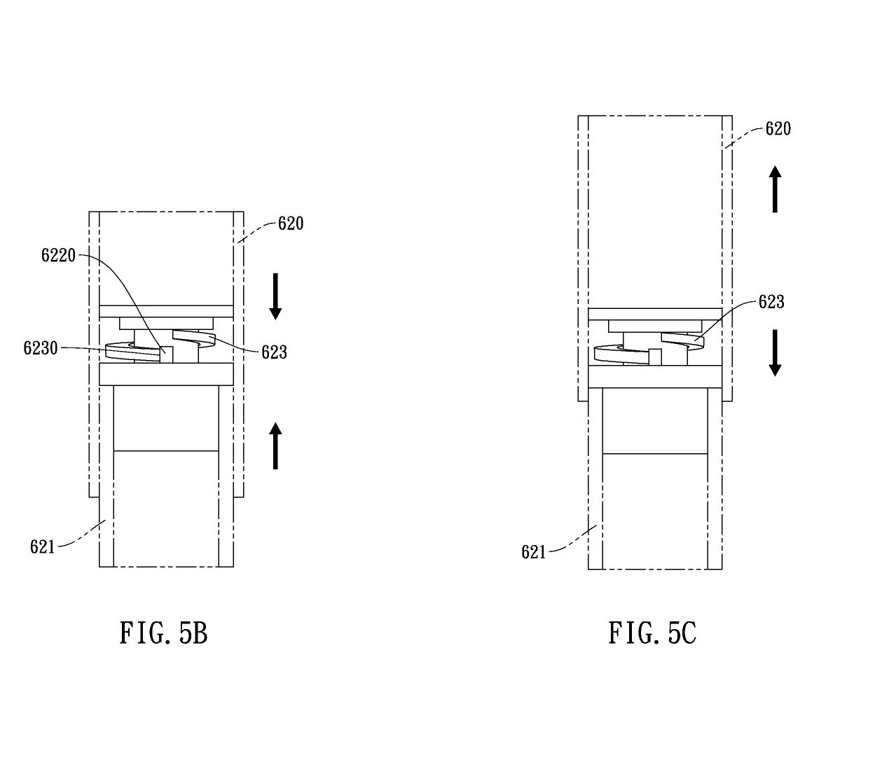

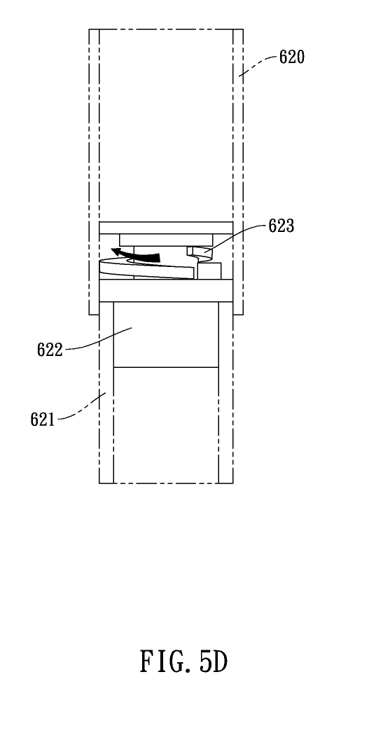

Referring to FIGS. 5A, 5B and 5C, a counterclockwise rotation of the shaft member 622 about the shell 620 can move and fasten the latch end 6230 in the recess 6220. Thus, the eccentric spiral member 623 and the shaft member 622 are fastened together. Further, the sleeving member 621 may freely slide up or down in the shell 620 (see FIG. 5C).

Referring to FIG. 5D in conjunction with FIG. 1, a subsequent clockwise rotation of the shaft member 622 about the shell 620 can move and disengage the latch end 6230 from the recess 6220. Thus, the eccentric spiral member 623 lockingly engages an inner surface of the shell 620 to prevent the sleeving member 621 from sliding in the shell 620.

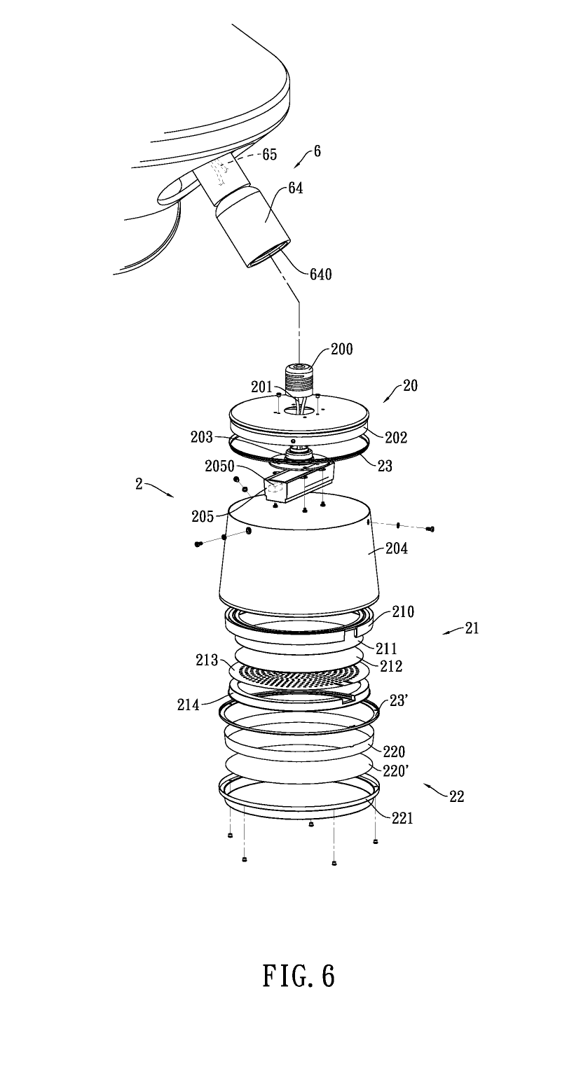

Referring to FIG. 6, a street light having a telescopic device for securing lamp to socket in accordance with a third preferred embodiment of the invention is shown. The characteristics of the third preferred embodiment are discussed in detail below. A socket member 64 of the telescopic device 6 has internal threads 640. The telescopic device 6 further comprises, from top to bottom, a conductive assembly 20 including a conductive externally threaded member 200 releasably secured to the internal threads 640 to be electrically interconnected an electrical wire 65 within the socket member 64 and another electrical wire 201, an upper cover 202 disposed on a lower portion of the conductive externally threadedly member 200, a seat 203 disposed below the upper cover 202, an aluminum shade 204 secured onto the upper cover 202, the shade 204 being lightweight, rigid, insulating, and good in heat dissipation, and an electrical ballast 205 having a temperature controller 2050, the electrical ballast 205 being electrically connected to another electrical wire 201 which is also electrically connected to the conductive externally threadedly member 200.

A light emitting assembly 21 is disposed in the shade 204 and comprises, from top to bottom, a fastening member 210, a heat sink 211, a light emitting member 212 electrically connected to the electrical ballast 205, an reflector film 213, and an internal mounting member 214.

A light transmission assembly 22 comprises, from top to bottom, first and second reflector members 220, 220′, and a lower ring 221 secured to bottom edge of the shade 204 so as to fasten the first and second reflector members 220, 220′ between the shade 204 and the lower ring 221.

Electricity is supplied from an external power source to the light emitting member 212 via the wire 65, the conductive externally threaded member 200, the wire 201, and the ballast 205. The emitted light passes through the reflector film 213, the first and second reflector members 220, 220′, and the lower ring 221 to illuminate a desired area. Strength of the emitted light can be adjusted by extending or collapsing the telescopic device 6. Excessive heat can be sufficiently removed by means of the heat sink 211. Further, the provision of the reflector film 213 and the first and second reflector members 220, 220′ can greatly decrease glare for eyes protection.

Further, a first waterproof ring 23 is provided between the upper cover 202 and the shade 204 and a second waterproof ring 23′ is provided between the lower ring 221 and the shade 204 for preventing water, dust, etc. from entering the light fixture 2. Moreover, the seat 203, the fastening member 210, and the lower ring 221 are formed of injection molding.

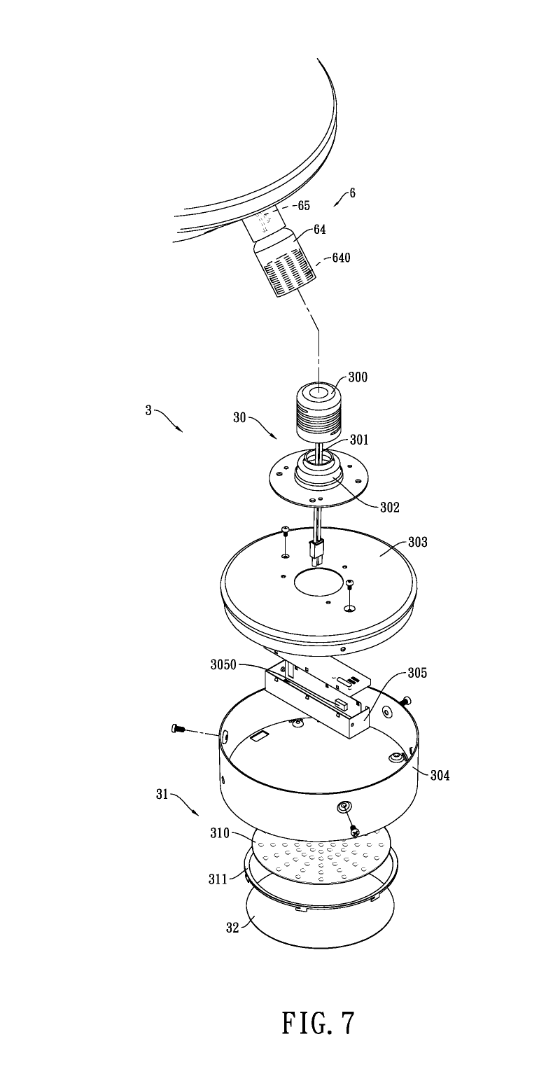

Referring to FIG. 7, a street light having a telescopic device for securing lamp to socket in accordance with a fourth preferred embodiment of the invention is shown. The characteristics of the fourth preferred embodiment are discussed in detail below. A socket member 64 of the telescopic device 6 has internal threads 640. The telescopic device 6 further comprises, from top to bottom, a conductive assembly 30 including a conductive externally threaded member 300 releasably secured to the internal threads 640 to be electrically interconnected an electrical wire 65 within the socket member 64 and another electrical wire 301, an upper cover 303 disposed on a lower portion of the conductive externally threadedly member 300, a seat 302 threadedly secured to the upper cover 303 therebelow, an aluminum cylindrical shade 304 secured onto the upper cover 303, the shade 304 being lightweight, rigid, insulating, and good in heat dissipation, and an electrical ballast 305 having a temperature controller 3050, the electrical ballast 305 being electrically connected to another electrical wire 301 which is also electrically connected to the conductive externally threadedly member 300.

A light emitting assembly 31 is disposed in the shade 304 and comprises, from top to bottom, a fastening member 311 and a light emitting member 310 electrically connected to the electrical ballast 305.

A light transmission assembly 32 is provided on a lower portion of the shade 304 to fasten the light emitting member 310 and the fastening member 311 between the shade 304 and the light transmission assembly 32.

Electricity is supplied from an external power source to the light emitting member 310 via the wire 65, the conductive externally threaded member 300, the wire 301, and the ballast 305. The emitted light passes through the light transmission assembly 32 to illuminate a desired area. Strength of light emitted from the light fixture 3 can be adjusted by extending or collapsing the telescopic device 6.

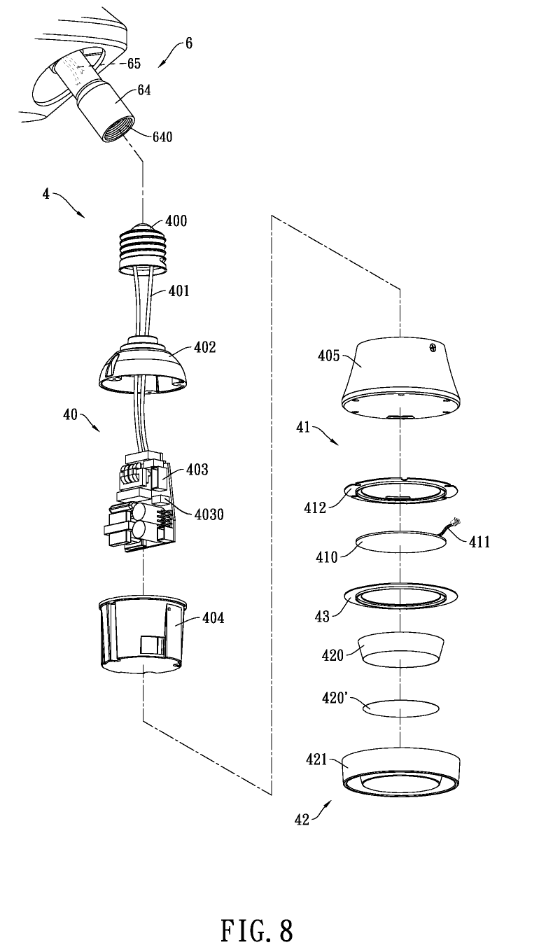

Referring to FIG. 8, a street light having a telescopic device for securing lamp to socket in accordance with a fifth preferred embodiment of the invention is shown. The characteristics of the fifth preferred embodiment are discussed in detail below. A socket member 64 of the telescopic device 6 has internal threads 640. The telescopic device 6 further comprises, from top to bottom, a conductive assembly 40 including a conductive externally threaded member 400 releasably secured to the internal threads 640 to be electrically interconnected an electrical wire 65 within the socket member 64 and another electrical wire 401, an upper cover 402 disposed on a lower portion of the conductive externally threadedly member 400, an electrical ballast 403 having a temperature controller 4030, the electrical ballast 403 being electrically connected to another electrical wire 401, an insulating shell 404 secured to the upper cover 402 to conceal the ballast 403, and an aluminum truncated conic shade 405 secured onto the shell 404, the shade 405 being lightweight, rigid, insulating, and good in heat dissipation.

A light emitting assembly 41 is disposed in the shade 405 and comprises a disc-shaped light emitting member 410 electrically connected to an electrical wire 411, and a ring-shaped reflector 412 secured to the light emitting member 410.

A light transmission assembly 42 comprises, from top to bottom, first and second reflector members 420, 420′, and a lower ring 421 secured to bottom edge of the shade 405 so as to fasten the first and second reflector members 420, 420′ between the light emitting member 410 and the lower ring 421.

Electricity is supplied from an external power source to the light emitting member 410 via the wire 65, the conductive externally threaded member 400, the wire 401, and the ballast 403. The emitted light passes through the reflector member 420 and the lower ring 421 to illuminate a desired area. Strength of light emitted from the light fixture 4 can be adjusted by extending or collapsing the telescopic device 6.

Further, a waterproof ring 43 is provided between the lower ring 421 and the shade 405 for preventing water, dust, etc. from entering the light fixture 4. Moreover, the upper cover 402 and the lower ring 421 are formed of injection molding.

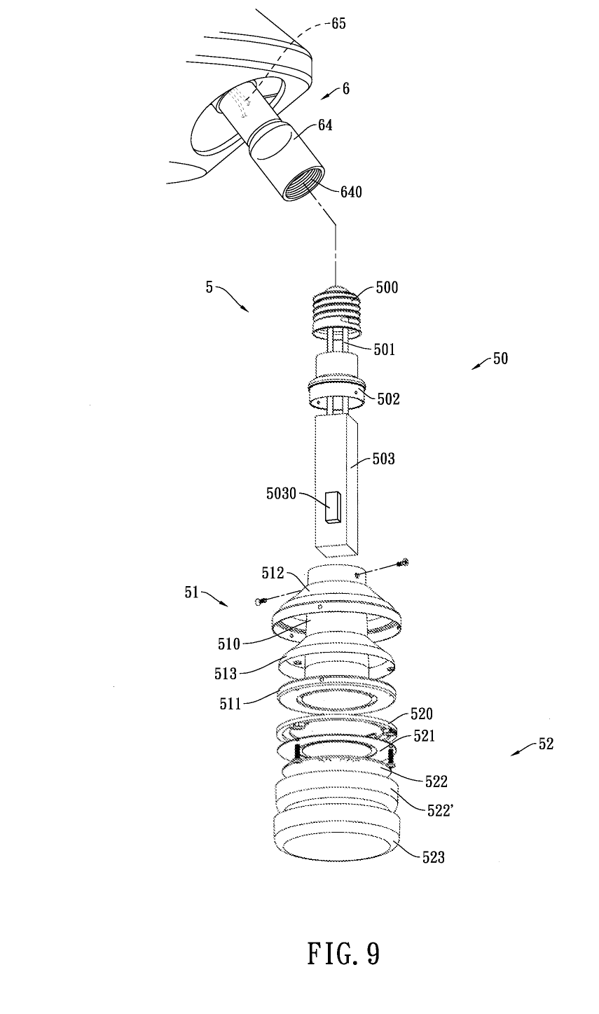

Referring to FIG. 9, a street light having a telescopic device for securing lamp to socket in accordance with a sixth preferred embodiment of the invention is shown. The characteristics of the sixth preferred embodiment are discussed in detail below. A socket member 64 of the telescopic device 6 has internal threads 640. The telescopic device 6 further comprises, from top to bottom, a conductive assembly 50 including a conductive externally threaded member 500 releasably secured to the internal threads 640 to be electrically interconnected an electrical wire 65 within the socket member 64 and another electrical wire 501, a seat 502 disposed below the conductive externally threaded member 500, and an electrical ballast 503 having a temperature controller 5030, the electrical ballast 503 being electrically connected to another electrical wire 501 which passes through the seat 502 to electrically connect to the conductive externally threaded member 500.

A light emitting assembly 51 comprises a truncated conic cover 512 on top, a shroud 510 in the upper cover 512, a lower ring-shaped light emitting member 511 electrically connected to the electrical ballast 503, and a truncated conic reflector 513 between the upper cover 512 and the light emitting member 511. The shroud 510 is made of aluminum and thus is lightweight, rigid, insulating, and good in heat dissipation.

A light transmission assembly 52 comprises, from top to bottom, an insulating ring 520, a ring-shaped heat sink 521, first and second reflector members 522, 522′, and a lower ring 523 secured to bottom edge of the light emitting member 511 so as to fasten the insulating ring 520, the heat sink 521, and the first and second reflector members 520, 520′ between the light emitting member 511 and the lower ring 523. Electricity is supplied from an external power source to the light emitting member 511 via the wire 65, the conductive externally threaded member 500, and the wire 501. The emitted light passes through the reflector 513 and the first and second reflector members 520, 520′, the lower ring 523, and the upper cover 512 in opposite direction to illuminate a desired area. Strength of light emitted from the light fixture 5 can be adjusted by extending or collapsing the telescopic device 6. Further, the seat 502, the upper cover 512 and the lower ring 523 are formed of injection molding.

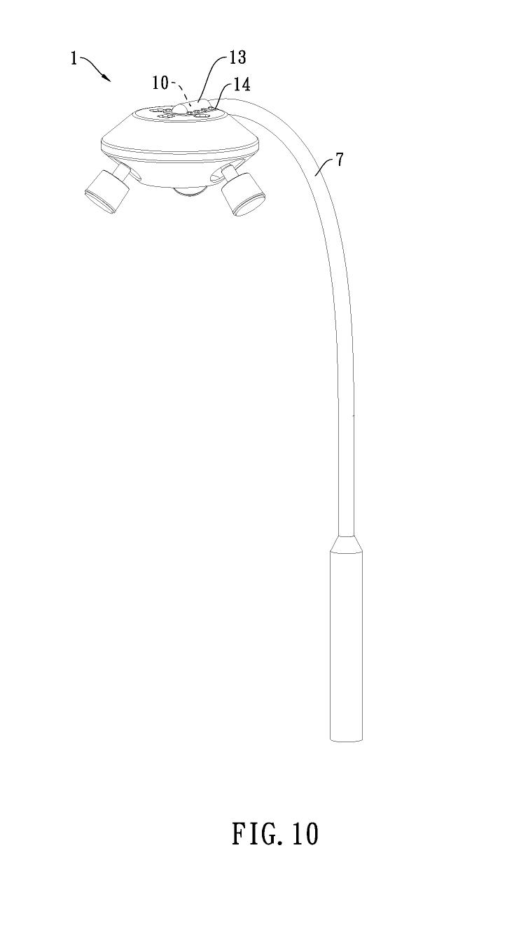

Referring to FIG. 10, fastening members (e.g., screws) 14 are provided to releasably secure one end of a pole-shaped lamp support 7 in the space 10 under the protrusion 13 of the fixture body 1 of a street light.

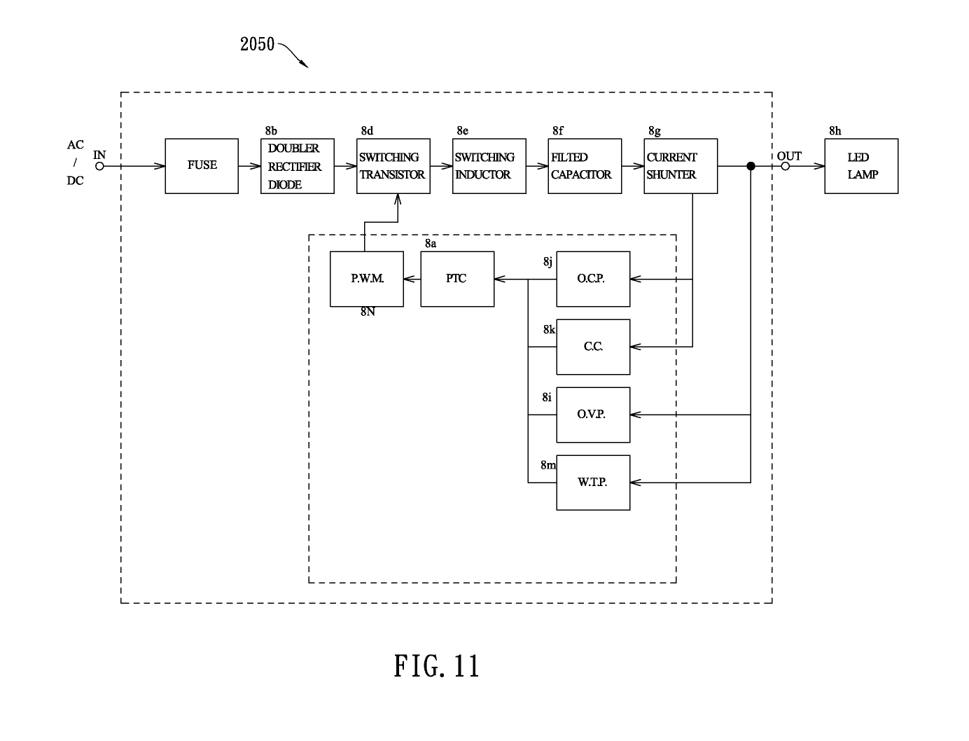

Referring to FIG. 11 in conjunction with FIGS. 6 to 9, one temperature controller 2050 of the plurality of temperature controllers 2050, 3050, 4030 and 5030 is discussed below as an exemplary example. The temperature controller 2050 is capable of measuring temperature and converting same into a signal which can be read by an electronic instrument. The components of the temperature controller 2050 are detailed below.

External AC/DC source is fed to a doubler rectifier diode 8b via a fuse. Next, it is supplied to a switching transformer 8d for lowering the voltage to a desired value. The low voltage is next filtered by a switching inductor 8e. Next, a filter capacitor 8f is employed to further filter the current. Further, the current flowing to a current shunter 8g energizes an LED lamp 8h via an OUT terminal. A portion of the current feeds back to the switching transformer 8d via parallel over current protection circuit 8j, constant current circuit 8k, over voltage protection circuit 8j and high temperature protection circuit 8m; a temperature control 8a; and a pulse width modulation 8N. Thus, a reliable, regulated power can be supplied to the lamp.

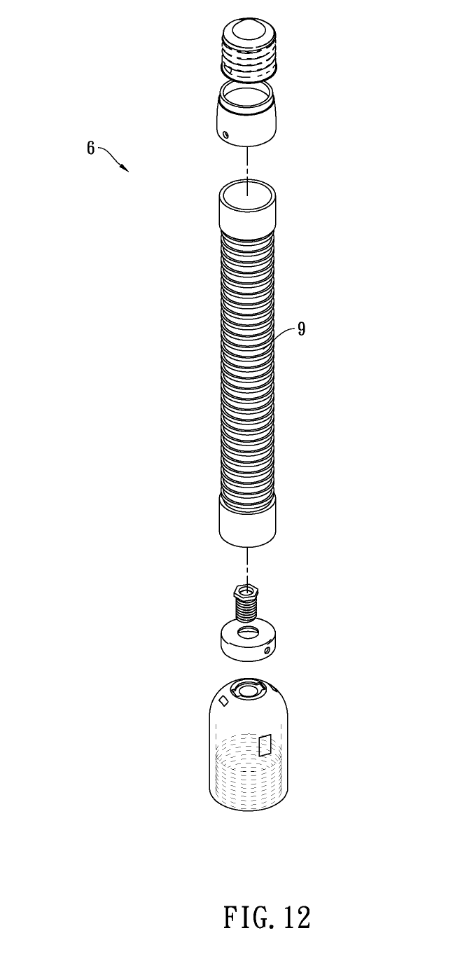

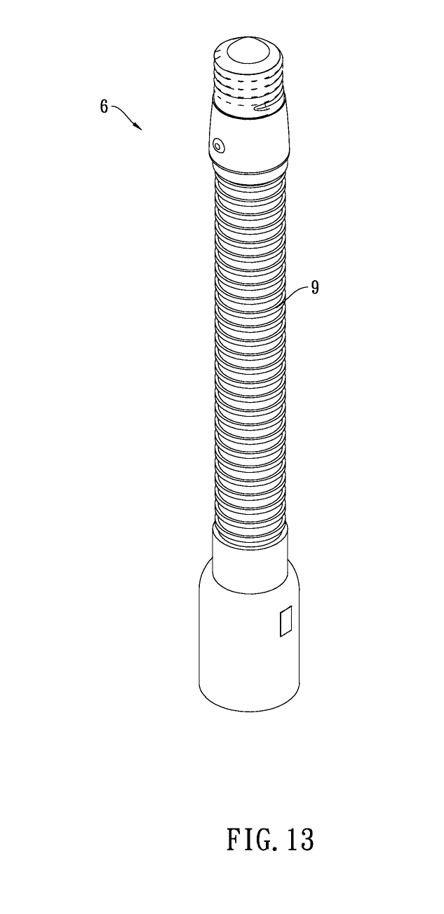

Referring to FIGS. 12 and 13, the sleeve 62 of the telescopic device 6 is replaced with a cylindrical bellows member 9 so that an illumination angle of the lamp can be adjusted as desired.

While the invention has been described in terms of preferred embodiments, those skilled in the art will recognize that the invention can be practiced with modifications within the spirit and scope of the appended claims.

What is claimed is:

1. A light comprising:
a hollow fixture body comprising a hollow top protrusion and at least one electrical socket disposed on the fixture body; and
at least one conductive telescopic device, each of the at least one conductive telescopic device comprising:
a conductive member releasably connected to an electrical socket in a fixture body, the electrical socket electrically connected to a first electrical wire;
a hollow member having one end secured to the conductive member;
a sleeve comprising a shell, a shaft member slidably disposed in a lower portion of the shell and including a recess on a surface, a sleeving member secured onto a lower portion of the shaft member, and an eccentric spiral member disposed on the shaft member and including a latch end complimentary to the recess;
a socket member for releasably holding at least one lamp;
a hollow connecting member having one end secured to the sleeving member and the other end secured to the socket member; and
a second electrical wire electrically connected to the conductive member and the socket member;
wherein a rotation of the shaft member about the shell in a first direction moves the latch end in the recess for locking so as to allow the sleeving member to slide in the shell; and
wherein a subsequent rotation of the shaft member about the shell in a second direction opposite the first direction disengages the latch end from the recess to lockingly engage the eccentric spiral member with an inner surface of the shell.

2. The light of claim 1, wherein the fixture body is made of metal and has an outer surface coated with transparent insulating paint capable of repelling water and being resistant to corrosion; and wherein the at least one electrical socket comprises a plurality of equally spaced electrical sockets.

3. The light of claim 1, wherein each of the at least one conductive telescopic device further comprises:
a socket member having internal threads;
a conductive assembly including a conductive externally threaded member releasably secured to the internal threads of the socket member to be electrically interconnected the second electrical wire within the socket member and a third electrical wire, an upper cover disposed on a lower portion of the conductive externally threadedly member, a seat disposed below the upper cover, an aluminum shade secured onto the upper cover, and an electrical ballast having a temperature controller, the electrical ballast being electrically connected to a fourth electrical wire electrically connected to the conductive externally threadedly member;
a light emitting assembly disposed in the shade and comprising a fastening member, a heat sink, a light emitting member electrically connected to the electrical ballast, an reflector film, and an internal mounting member; and
a light transmission assembly comprising first and second reflector members and a lower ring secured to a bottom edge of the shade so as to fasten the first and second reflector members between the shade and the lower ring.

4. The light of claim 3, wherein the shade is made of aluminum, further comprising a first waterproof ring between the upper cover and the shade and a second waterproof ring provided between the lower ring and the shade; and wherein the hollow cylindrical member, the hollow connecting member, the seat, the fastening member, and the lower ring are formed of injection molding.

5. The light of claim 1, wherein each of the at least one conductive telescopic device further comprises:
a socket member having internal threads;
a conductive assembly including a conductive externally threaded member releasably secured to the internal threads of the socket member to be electrically interconnected the second electrical wire within the socket member and a third electrical wire, an upper cover disposed on a lower portion of the conductive externally threadedly member, a seat threadedly secured to the upper cover therebelow, a cylindrical shade secured onto the upper cover, and an electrical ballast having a temperature controller, the electrical ballast being electrically connected to a fourth electrical wire electrically connected to the conductive externally threadedly member;
a light emitting assembly disposed in the shade and comprising a fastening member and a light emitting member electrically connected to the electrical ballast; and
a light transmission assembly provided on a lower portion of the shade to fasten the light emitting member and the fastening member between the shade and the light transmission assembly.

6. The light of claim 5, wherein the shade is made of aluminum and wherein both the hollow cylindrical member and the hollow connecting member are formed of injection molding.

7. The light of claim 1, wherein each of the at least one conductive telescopic device further comprises:
a socket member having internal threads;
a conductive assembly including a conductive externally threaded member releasably secured to the internal threads of the socket member to be electrically interconnected the second electrical wire within the socket member and a fifth electrical wire, an upper cover disposed on a lower portion of the conductive externally threadedly member, an electrical ballast having a temperature controller, the electrical ballast being electrically connected to the fifth electrical wire, an insulating shell secured to the cover to conceal the ballast, and a truncated conic shade secured onto the shell;
a light emitting assembly disposed in the shade and comprising a disc-shaped light emitting member electrically connected to a sixth electrical wire, and a ring-shaped reflector secured to the light emitting member; and
a light transmission assembly comprising first and second reflector members and a lower ring secured to a bottom edge of the shade so as to fasten the first and second reflector members between the light emitting member and the lower ring.

8. The light of claim 7, wherein the shade is made of aluminum, further comprising a first waterproof ring between the upper cover and the shade and a second waterproof ring provided between the lower ring and the shade; and wherein the hollow cylindrical member, the hollow connecting member, the upper cover, and the lower ring are formed of injection molding.

9. The light of claim 1, wherein each of the at least one conductive telescopic device further comprises:
a socket member having internal threads;
a conductive assembly including a conductive externally threaded member releasably secured to the internal threads of the socket member to be electrically interconnected the second electrical wire within the socket member and a seventh electrical wire, a seat disposed below the conductive externally threaded member, and an electrical ballast having a temperature controller, the electrical ballast being electrically connected to the seventh electrical wire passing through the seat to electrically connect to the conductive externally threaded member;
a light emitting assembly comprising a truncated conic cover on top, a shroud in the cover, a lower ring-shaped light emitting member electrically connected to the electrical ballast, and a truncated conic reflector between the cover and the light emitting member; and
a light transmission assembly comprising an insulating ring, a ring-shaped heat sink, first and second reflector members, and a lower ring secured to a bottom edge of the light emitting member so as to fasten the insulating ring, the heat sink, and the first and second reflector members between the light emitting member and the lower ring.

10. The light of claim 9, wherein the shade is made of aluminum, and wherein the hollow cylindrical member, the hollow connecting member, the seat, the upper cover, and the lower ring are formed of injection molding.

11. A conductive telescopic device, comprising:
a conductive member releasably connected to an electrical socket in a fixture body;
a hollow member having one end secured to the conductive member;
a sleeve comprising a shell, a shaft member slidably disposed in a lower portion of the shell and including a recess on a surface, a sleeving member secured onto a lower portion of the shaft member, and an eccentric spiral member disposed on the shaft member and including a latch end complimentary to the recess;
a socket member for releasably holding at least one lamp;
a hollow connecting member having one end secured to the sleeving member and the other end secured to the socket member; and
an electrical wire electrically connected to the conductive member and the socket member;
wherein a rotation of the shaft member about the shell in a first direction moves the latch end in the recess for locking so as to allow the sleeving member to slide in the shell; and
wherein a subsequent rotation of the shaft member about the shell in a second direction opposite the first direction disengages the latch end from the recess to lockingly engage the eccentric spiral member with an inner surface of the shell.
